(19) United States
(12) Patent Application Publication
(10) Pub. No.: US 2018/0246293 A1
(43) Pub. Date: Aug. 30, 2018

(54) AUTOFOCUS ADJUSTMENT APPARATUS

(71) Applicant: MICRO ACTUATOR CO., LTD., Seongnam-si (KR)

(72) Inventors: Dae-soon LIM, Yongin-si (KR); Hak-ku YOON, Suwon-si (KR); Myung-won CHOI, Yongin-si (KR); Dong-sung LEE, Pyeongtaek-si (KR)

(21) Appl. No.: 15/894,132

(22) Filed: Feb. 12, 2018

(30) Foreign Application Priority Data
Feb. 24, 2017 (KR) 10-2017-0024659

(51) Int. Cl. G02B 7/09; G02B 7/02

(52) U.S. Cl. CPC G02B 7/09; G02B 7/022

(57) ABSTRACT

An autofocus adjustment apparatus is provided. The autofocus adjustment apparatus includes a base formed with a light-through hole, a carrier inserted into the base and configured to receive a lens barrel configured of one or more lenses, a magnet installed in one surface of the carrier, a coil installed in the base to face the magnet, and at least one or more balls located between the carrier and the base and configured to support the carrier to move along an optical axis direction of the lenses.

### CROSS-REFERENCE TO RELATED APPLICATIONS

This application claims priority from Korean Patent Application No. 10-2017-0024659, filed on Feb. 24, 2017, in the Korean Intellectual Property Office, the disclosure of which is incorporated herein by reference in its entirety.

### BACKGROUND OF THE INVENTION

### Field of the Invention

Apparatuses and methods consistent with exemplary embodiments relate to an autofocus adjustment apparatus, and more particularly, to an autofocus adjustment apparatus capable of imaging a sharp screen by reliably adjusting a focal distance.

### Description of the Related Art

Nowadays, camera lens assemblies included in small mobile apparatuses such as mobile communication terminals may display 13 million pixels on a screen and implement high resolution like conventional digital cameras. With high-performance camera lens assemblies mounted on the mobile communication terminals, various functions such as an optical zoom function as well as an autofocus adjustment function and an image stabilization function may be employed.

The camera lens assemblies may image a clear and sharp image according to a distance between a camera and a subject through the autofocus adjustment function among these functions.

However, in the related camera lens assemblies having an autofocus adjustment function, a lens carrier may deviate from a moving path and may not accurately move along the moving path due to manufacturing tolerances of parts of the camera lens assembly in response to the lens carrier being forward/backward moved to an optical axis direction for autofocus adjustment.

### SUMMARY OF THE INVENTION

Exemplary embodiments may overcome the above disadvantages and other disadvantages not described above. Also, an exemplary embodiment is not required to overcome the disadvantages described above, and an exemplary embodiment may not overcome any of the problems described above.

One or more exemplary embodiments relate to an autofocus adjustment apparatus capable of imaging a sharp screen by reliably adjusting a focal distance.

According to an aspect of an exemplary embodiment, there is provided an autofocus adjustment apparatus including a base formed with a light-through hole; a carrier inserted into the base and configured to receive a lens barrel configured of one or more lenses; a magnet installed in one surface of the carrier; a coil installed in the base to face the magnet; and at least one or more balls located between the carrier and the base and configured to support the carrier to move along an optical axis direction of the lenses.

The base may be formed with a receiving groove configured to receive the carrier and guide grooves which are coupled to the receiving groove along the optical axis direction and the balls are inserted thereinto.

The guide grooves may include a main guide groove located in one side of the magnet; and an auxiliary guide groove located in the other side of the magnet.

The balls may be stacked in and inserted into the main guide groove and the auxiliary guide groove in different numbers.

The balls inserted into the main guide groove may support the carrier to an X-Y direction and the balls inserted into the auxiliary guide groove may support the carrier to a Y-direction.

The balls inserted into the main guide groove may be in three-point contact between the carrier and the base and the balls inserted into the auxiliary guide groove may be in two-point contact between the carrier and the base.

The carrier may include a guide protrusion which protrudes so that at least one end of the guide protrusion is inserted into the main guide groove.

The main guide groove may be partitioned into a first main guide groove and a second main guide groove through the guide protrusion and the balls may be stacked in the first main guide groove and the second main guide groove.

The guide protrusion may include inclined surfaces which are in contact with the balls located in the first and second main guide grooves.

The balls located in the first and second main guide grooves may be in three-point contact between the inclined surfaces and the first and second main guide grooves.

A plurality of polarities may be alternately formed in the magnet.

Additional aspects and advantages of the exemplary embodiments are set forth in the detailed description, and will be obvious from the detailed description, or may be learned by practicing the exemplary embodiments.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is a perspective view illustrating an autofocus adjustment apparatus according to an exemplary embodiment;

FIG. 2 is an exploded perspective view illustrating an autofocus adjustment apparatus according to an exemplary embodiment;

FIG. 3 is a plane view illustrating an example that a cover is omitted in an autofocus adjustment apparatus according to an exemplary embodiment;

FIG. 4 is an enlarged view illustrating an A portion of the autofocus adjustment apparatus of FIG. 3;

FIG. 5 is a cross-sectional diagram illustrating the autofocus adjustment apparatus take along line B-B of FIG. 3;

FIG. 6 is a plan view illustrating an example that a cover is omitted in an autofocus adjustment apparatus according to another exemplary embodiment;

FIG. 7 is a plane view illustrating an example that a cover is omitted in an autofocus adjustment apparatus according to another exemplary embodiment; and

FIG. 8 is an exploded perspective view illustrating an autofocus adjustment apparatus according to another exemplary embodiment.

### DETAILED DESCRIPTION OF THE EXEMPLARY EMBODIMENTS

Terms used in exemplary embodiments will be described in brief, and exemplary embodiments will be described in detail.

As the terminology used herein is for the purpose of describing the specification and claims, general terms are selected in consideration of functions in the various exemplary embodiments. It will be understood that the terms used herein may be changed depending on the intention of the technician in the art to which the present disclosure belongs, legal or technical interpretation, appearance of new technology, and the like. A portion of the terms used herein may be terms arbitrarily selected by the applicant.

It will be understood that the terms used herein should be interpreted as the meaning defined herein. Unless otherwise defined, all terms (including technical and scientific terms) used herein have the same meaning as commonly understood by one of ordinary skill in the art to which this inventive concept belongs.

Like references or symbols used in the accompanying drawings herein denote parts or elements which substantially perform the same functions. For convenience of description and understandings, like references or symbols are used in other exemplary embodiments. For example, although all the elements indicated by like references in a plurality of drawings are illustrated, the plurality of drawings may not refer to one exemplary embodiment.

It will be understood that, although the terms first, second, etc. may be used herein in reference to elements of the invention, such elements should not be construed as limited by these terms. The terms are used only to distinguish one element from other elements. For example, the elements associated to the ordinal numbers should not be limited to the use order or arrangement order according to the numbers. If necessary, a first element may refer to a second element, and similarly, the second element may refer to the first element.

The terminology used herein to describe embodiments of the invention is not intended to limit the scope of the invention. The articles “a,” “an,” and “the” are singular in that they have a single referent; however, the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, integers, steps, operations, elements, components, and/or groups thereof, but do not preclude the presence or addition of one or more other features, integers, steps, operations, elements, components, and/or groups thereof.

In exemplary embodiments, the phrase “coupling” of any portion to another portion may include “directly coupled” as well as “indirectly coupled” with other element interposed therebetween. The term “a certain portion including a certain element” may mean that another element is not excluded but further included” unless specifically otherwise defined.

Hereinafter, an exemplary embodiment of the present disclosure will be described with reference to the accompanying drawings.

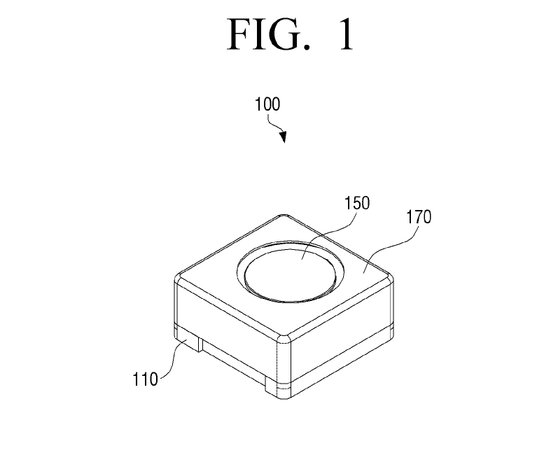

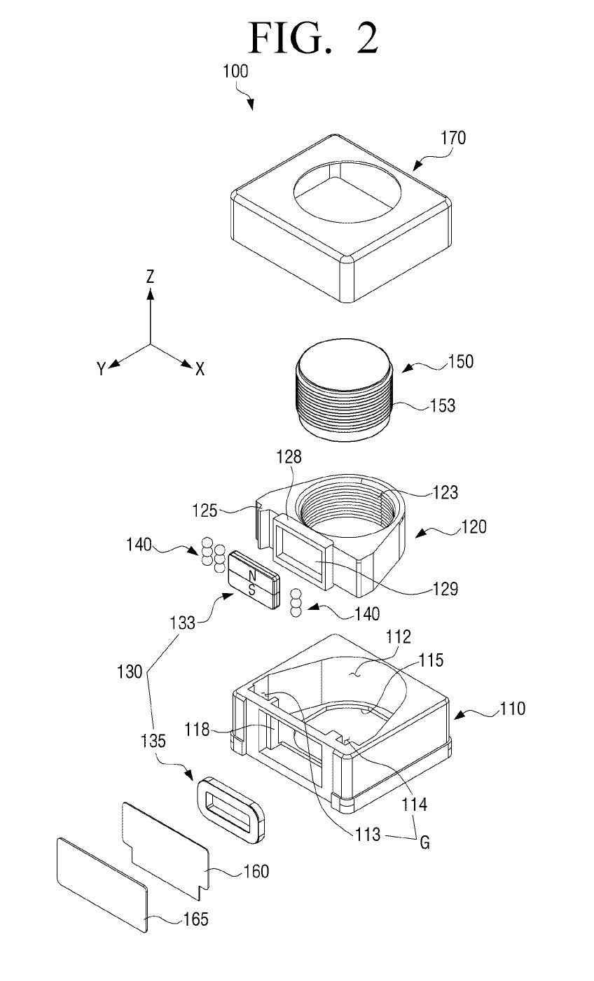

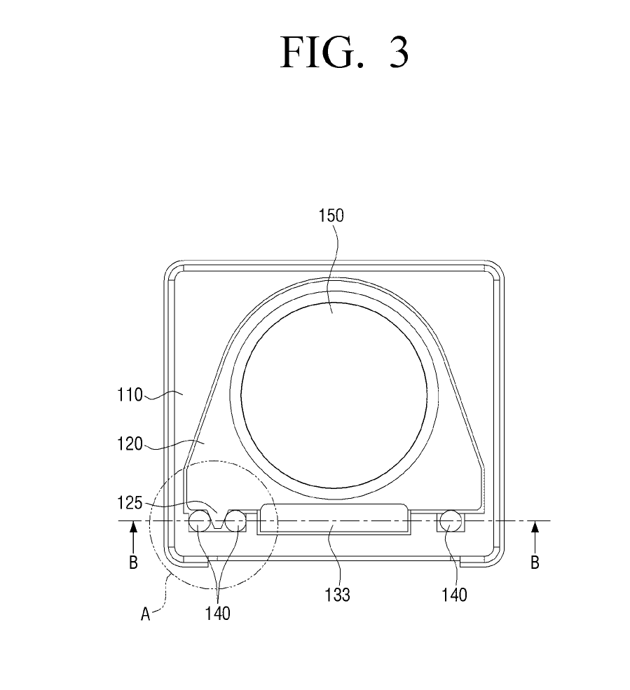

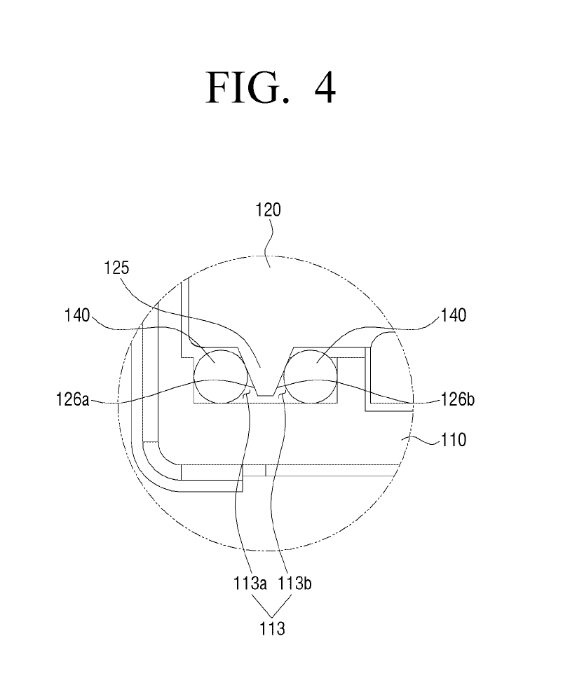

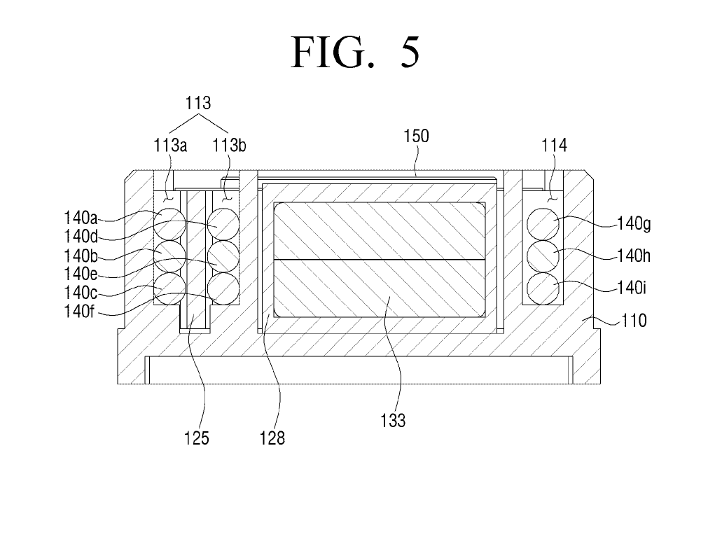

FIG. 1 is a perspective view illustrating an autofocus adjustment apparatus according to an exemplary embodiment and FIG. 2 is an exploded perspective view illustrating an autofocus adjustment apparatus according to an exemplary embodiment. FIG. 3 is a plane view illustrating an example that a cover is omitted in an autofocus adjustment apparatus according to an exemplary embodiment and FIG. 4 is an enlarged view illustrating an A portion of the autofocus adjustment apparatus of FIG. 3. FIG. 5 is a cross-sectional diagram illustrating the autofocus adjustment apparatus take along line B-B of FIG. 3.

Referring to FIGS. 1 to 5, an autofocus adjustment apparatus 100 according to an exemplary embodiment may include a base 110 of which a light-through hole 115 is formed in a central portion, a carrier 120 inserted into and installed in the base 110, a driving unit 130 configured to move the carrier 120 along an optical axis direction, and at least one or more balls 140 located between the base 110 and the carrier 120. The driving unit 130 may include a magnet 133 installed in one surface of the carrier 120 and a coil 135 installed in the base 110 to face the magnet 133.

A receiving groove 112 which receives the carrier 120 and guide grooves G into which the balls 140 are inserted may be formed in the base 110. The receiving groove 112 may have a shape corresponding to an outer surface of the carrier 120 and the guide grooves G may be coupled to the receiving groove 112 and may have a concave shape from an inner surface of the base 110 so that the balls 140 are inserted into the guide grooves G The lower ends of the guide grooves G may be located to be stepped with a lower end of the receiving groove 112.

The guide grooves G may include a main guide groove 113 located in one-side portion of the base 110 on the basis of the coil 135 (or magnet 133) and an auxiliary guide groove 114 located in the other-side portion of the base 110 on the basis of the coil 135 (or magnet 133). For example, the balls 140 may be inserted into the main guide groove 113 and the auxiliary guide groove 114 and may be located in the same plane of the carrier 120 and thus the carrier 120 may easily slide to the optical axis direction through a rolling motion.

In this example, a plurality of balls may be stacked in and inserted into the main guide groove 113 so that the carrier 120 may be supported to the X-Y direction without shaking.

One side of the carrier 120 may be supported through the plurality of balls 140 inserted into the main guide groove 113 and the plurality of balls inserted into the auxiliary guide groove 114 may be only in two-point contact between the carrier 120 and the base 110 and may efficiently and stably support the other side of the carrier 120 opposite to the one side thereof.

An opening 118 may be formed in one-side surface of the base 110 and the magnet 133 installed in one surface of the carrier 120 may be exposed to the outside through the opening. The coil 135 may be installed in outer surface of the base 110 formed with the opening 118 and one side of the coil 135 may be located to face the magnet 133. For example, the coil 135 may have a donut shape.

One surface of a substrate 160 may be located in the other side of the coil 135 and a terminal part (not shown) configured to apply power to the coil 135 may be formed in the substrate 160. The coil 135 may generate driving force through interaction with the magnet 133 by receiving the power from the substrate 160 through the terminal part. For example, the substrate 160 may be a flexible printed circuit board (FPCB) and the coil 135 may be electrically coupled to the substrate 160 and simultaneously fixedly installed in the substrate 160.

A yoke 165 may be installed in the other surface of the coil 135 and fixed to the outer surface of the base 110. The yoke 165 may be formed to have a wider width than the coil 135 and thus the intensity of the magnetic field formed between the coil 135 and the magnet 133 may be increased and simultaneously the magnetic field may be expanded.

A hall sensor (not shown) may be mounted on the substrate 160. The hall sensor may be installed to be spaced close to an outer circumferential surface of the magnet 133 and may be electrically coupled to the substrate 160. The hall sensor may sense a position of the carrier 120 (or position of a lens) and the moving direction and the moving distance of the carrier 120 to be moved may be calculated based on the location position of the lens sensed through the hall sensor in the autofocus adjustment operation.

The position of the hall sensor may be changed to any position in which the hall sensor is disposed in parallel to the magnet 133 installed in a carrier 120 side and faces the magnet 133, for example, an upper portion, a side portion, a lower portion, and the like of the coil 135.

The carrier 120 may have a hollow shape to correspond to the light-through hole 115 formed in the base 110 and the outer surface of the carrier 120 may have a shape corresponding to the receiving groove 112 formed in the base 110. The carrier 120 may include a guide protrusion 125 and the guide protrusion 125 may protrude to a position corresponding to the main guide groove 113 and at least one end of the guide protrusion 125 may be inserted into the main guide groove 113.

Referring to FIG. 4, the guide protrusion 125 may be located eccentrically from a central portion of one surface of the carrier 120 to one-side portion of the one surface of the carrier.

The guide protrusion 125 may have inclined surfaces 126a and 126b in both-side portions to be in contact with the balls 140 located in the main guide groove 113 and the main guide groove 113 may be partitioned into a first main guide groove 113a and a second main guide groove 113b through the guide protrusion 125 inserted into the main guide groove 113. Accordingly, the balls 140 located in the first and second main guide grooves 113a and 113b may be in three-point contact between the first and second main guide grooves and the inclined surfaces 126a and 126b.

For example, the balls 140 may be inserted into the first and second main guide grooves 113a and 113b and the auxiliary guide groove 114 and three balls 140 may be inserted into and stacked in each of the guide grooves 113a, 113b, and 114. In this example, the inner surface of the base 110 and the outer surface of the carrier 120 may be in at least three-point contact through the balls inserted into the main guide groove.

A coupling position of the carrier 120 and the base 110 may be set through the guide protrusion 125 formed in the carrier 120. The balls 140 inserted into the main guide groove 113 and the auxiliary guide groove 114 may be stacked in different numbers from each other.

In response to the balls 140 inserted into the main guide groove 113 being in contact with the inclined surfaces 126a and 126b to support one-side portion of the carrier 120 to the X-Y direction, the other-side portion of the carrier 120 may be inclined to the Y-direction due to the effect of the magnet 133. The balls 140 inserted into the auxiliary guide groove 114 may support the other-side portion of the carrier 120 with only the two-point contact to the Y-direction and thus the carrier 120 may be efficiently supported with minimum friction force.

A coupling member 128 which the magnet 133 is installed therein and coupled thereto may be provided in the one surface of the carrier 120. For example, the coupling member 128 may be located in the same plane with the guide protrusion 125 and may have a shape protruding from the one surface of the carrier 120. An installation groove 129 on which the magnet 133 is mounted may be formed in the coupling member 128.

A plurality of magnets 133 may be provide so that polarities of the magnets are alternately arranged. The magnets 133 may be disposed to overlap each other so that the magnets have different poles. For example, an N pole and an S pole may be magnetized in one-side portions and the other-side portions of an inner surface and an outer surface of the magnet 133. In this example, the N pole may be magnetized in one-side portion of a surface of the magnet 133 facing the coil 135 and the S pole may be magnetized in the other-side portion of the facing surface of the magnet 133. The S pole may be magnetized in one-side portion of a surface of the magnet 133 opposite to the facing surface of the magnet 133 and the N pole may be magnetized in the other-side portion of the opposite surface of the magnet 133.

Accordingly, the four poles, for example, the N poles and the S poles may be magnetized in both-side portions of the inner surface and the outer surface of the magnet 133 and thus the magnetic field section that the intensity of the magnetic field detected through the hall sensor is uniformly increased and reduced may be formed.

A lens barrel 150 may be coupled to an inner circumferential surface of the carrier 120 in which the hollow is formed. For example, screw threads 123 and 153 corresponding to each other may be formed in the inner circumferential surface of the carrier 120 and an outer circumferential surface of the lens barrel 150 and thus the lens barrel 150 may be screw-fastened to the carrier 120.

In the autofocus adjustment apparatus 100 according to an exemplary embodiment, the carrier 120 may slide to the base 110 and may be coupled to the base 110. Accordingly, the lens barrel 150 may be separated from the carrier 120 even after the lens barrel 150 is coupled to the carrier 120.

Accordingly, in replacement of the defective lens barrel 150, only the lens barrel 150 may be separated from the carrier 120 and repaired and in response to the defective lens being included in the lens barrel 150, the autofocus adjustment apparatus 100 may not be necessarily discarded.

The coupling of the lens barrel 150 and the carrier 120 is not limited to the screw-fastening and the lens barrel 150 and the carrier 120 may be detachably coupled through press fitting, bonding coupling, a combination thereof, and the like.

For example, in the above-described autofocus adjustment apparatus 100 according to an exemplary embodiment, through the structure that the guide protrusion 125 is inserted into the main guide groove 113 and the carrier is supported through the plurality of balls 140, the lens carrier 120 may be driven along the preset path to the optical axis direction without shaking. Accordingly, the lens carrier 120 may accurately and stably perform driving to the forward and backward directions even in occurrence of the manufacturing tolerances of the parts.

The cover 170 may be coupled to the base 110 to cover a side surface and a top surface of the base 110. The cover 170 may shield the electromagnetic effect from the outside and for example, a material such as iron and the like advantageous for shielding the electromagnetic wave may be used for the cover 170.

The cover 170 may have a size and a shape corresponding to a size and a shape of the base 110.

Hereinafter, a driving process of the autofocus adjustment apparatus according to an exemplary embodiment will be described. It is defined that the term ‘forward direction’ of the carrier described to be later is a direction that the carrier moves to an increasing direction of a gap between one surface of the base and one surface of the carrier facing thereto and the term ‘backward direction’ of the carrier described to be later is a direction that the carrier moves to a reducing direction of the gap between the one surface of the base and the one surface of the carrier facing thereto.

For example, in response to a current being applied to the coil 135 to one direction, the electromagnetic force may be generated between the magnet 133 and the coil 135 and thus the magnet 133 may be pushed to the forward direction. Accordingly, the carrier 120 may forward drive to the optical axis direction. The carrier 120 may forward drive and thus a gap between a bottom surface of the base 110 and the lower surface of the carrier facing thereto may be increased.

The plurality of balls 140 may slidably support the carrier 120 and may guide the carrier 120 to be stably forward driven. The balls 140 may be stacked and located in the main guide groove 113 and the auxiliary guide groove 114. The hall sensor may detect the magnetic intensity of the magnet 133 which is changed according to the change in the position of the magnet 133 and may transmit the detected signal to a controller (not shown) of a portable apparatus (not shown) mounted with the autofocus adjustment apparatus 100.

The controller may control a forward moving distance of the carrier 120 through the detected signal of the hall sensor. For example, the controller may control the forward or backward moving distance by controlling the current of the coil 135 of the driving unit 130 in response to the moving distance of the carrier 120 being set.

As the current applied to the coil 135 is applied to a direction opposite to the application direction of the current in the forward operation of the carrier 120, the electromagnetic force in an opposite direction to the forward operation of the carrier 120 may be generated between the coil 135 and the magnet 133 in the backward operation of the carrier and thus the magnet 133 may be pushed to the backward direction of the magnet 133 opposite to the forward direction of the carrier 120. Accordingly, the carrier 120 may backward drive.

The carrier 120 may backward drive and thus the gap between the bottom surface of the base 110 and the lower surface of the carrier 120 facing thereto may be reduced.

Accordingly, the carrier may be slidably supported through the plurality of balls 140 and may stably backward drive.

As described above, in the driving of the carrier 120 for near and far focusing, the carrier 120 may be slidably guided with respect to the base 110 through the plurality of balls 140. Accordingly, the plurality of balls 140 may support the carrier 120 through plural-point-contact between the base 110 and the carrier 120 and thus shaking due to the external shock or various vibrations may be prevented. The maintenance points of the tolerance in a manufacturing process may be reduced and thus the dimension maintenance may be easy.

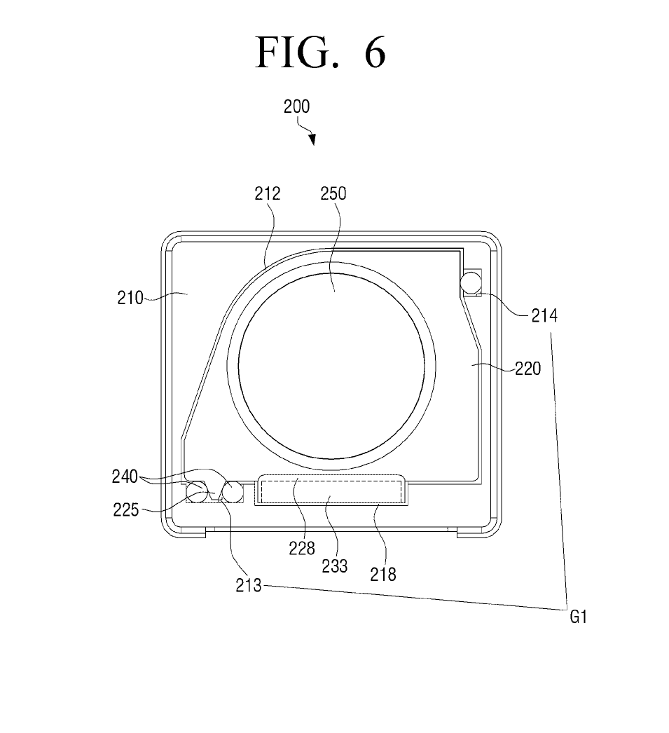

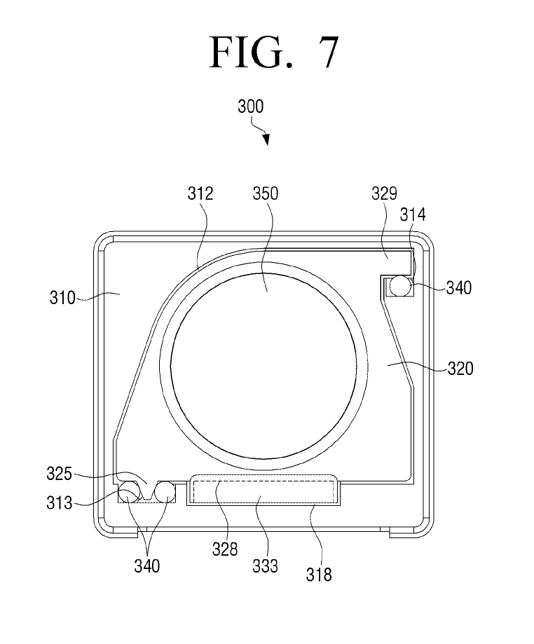

FIG. 6 is a plan view illustrating an example that a cover is omitted in an autofocus adjustment apparatus according to another exemplary embodiment and FIG. 7 is a plane view illustrating an example that a cover is omitted in an autofocus adjustment apparatus according to another exemplary embodiment.

Hereinafter, for clarity, the autofocus adjustment apparatuses according to other exemplary embodiments will be described based on a difference from the autofocus adjustment apparatus according to an exemplary embodiment described in FIGS. 1 to 5 and omitted description for the configuration may be replaced with the above-described description.

Referring to FIG. 6, the autofocus adjustment apparatus according to another exemplary embodiment may include a base 210, a carrier 220 inserted into and installed in the base, a driving unit (not shown) configured to move the carrier 220 along an optical axis direction, and at least one or more balls 240 located between the base 210 and the carrier 220.

A receiving groove 212 configured to receive the carrier 220 and guide grooves G1 into which the balls 240 are inserted may be formed in the base 210. The receiving groove 212 may have a shape corresponding to an outer surface of the carrier 220 and the guide groove G1 may be coupled to the receiving groove 212 and may have a concave shape from an inner surface of the base 210 so that the balls 240 are inserted into the guide groove G1.

An opening 218 which exposes a magnet 233 to the outside may be formed in one surface of the base 210 and the magnet 233 and a coil (not shown) may be installed to face each other through the opening 218. The guide grooves G1 may include a main guide groove 213 located in one side of the magnet 233 and an auxiliary guide groove 214 located in the other side of the magnet 233. The balls 240 may be stacked and located in the main guide groove 213 and the auxiliary guide groove 214.

The main guide groove 213 may be located in parallel to the magnet 233 and the plurality of balls 240 inserted into the main guide groove 213 may support one surface of the carrier 220. The auxiliary guide groove 214 may be located across the optical axis direction from the main guide groove 213 and the plurality of balls 240 inserted into the auxiliary guide groove 214 may support another surface of the carrier 220. For example, the auxiliary guide groove 214 may be formed in any one surface of the base 210 which is different from the one surface in which the magnet 233 is located.

Referring to FIG. 7, a carrier 320 may include a tail portion 329 which protrudes so that at least one portion of the tail portion 329 is inserted into an auxiliary guide groove 314. A plurality of balls 340 inserted into the auxiliary guide groove 314 may be in contact with the tail portion 329 to slidably support the carrier 320 along a base 310.

The auxiliary guide grooves 214 and 314 in the autofocus adjustment apparatuses 200 and 300 according to other exemplary embodiments described in FIGS. 6 and 7 may be formed in an oblique direction to the main guide grooves 213 and 313. The plurality of balls 340 inserted into the main guide grooves 213 and 313 and the auxiliary guide grooves 214 and 314 may slidably support one surfaces and the other surfaces of the carriers 220 and 320 along the optical axis direction.

As the auxiliary guide grooves 214 and 314 and the main guide grooves 213 and 313 are formed in different surfaces from each other, the sizes and locations of the magnets 233 and 333 configured to drive the carriers 220 and 320 may be variously modified. The sizes of the magnets 233 and 333 installed in the carriers 220 and 320 may be increased and thus the driving force of the carriers 220 and 320 may be intensified.

FIG. 6, reference numeral 225 which has not been described in the detailed description refers to a guide protection, reference numeral 228 refers to a coupling member, and reference numeral 250 refers to a lens barrel. FIG. 7, reference numeral 312 which has not been described in the detailed description refers to a receiving groove, reference numeral 318 refers to an opening, reference numeral 325 refers to a guide protection, and reference numeral 328 refers to a coupling member.

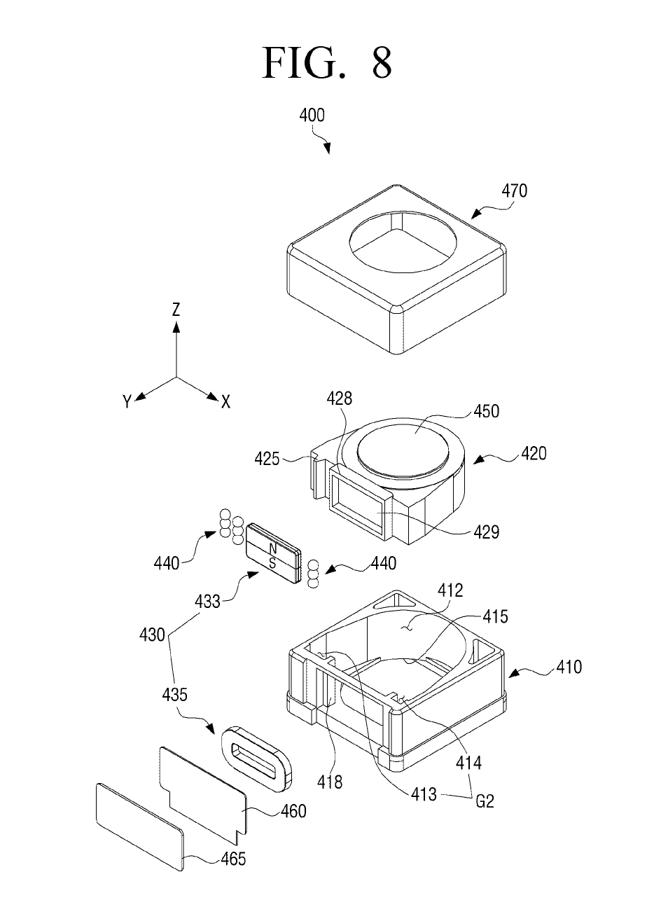

FIG. 8 is an exploded perspective view illustrating an autofocus adjustment apparatus according to another exemplary embodiment. Hereinafter, for clarity, the autofocus adjustment apparatus according to another exemplary embodiment will be described based on differences from the autofocus adjustment apparatuses according to the various exemplary embodiments described in FIGS. 1 to 7 and omitted description for the configuration may be replaced with the above-described description.

An autofocus adjustment apparatus 400 according to another exemplary embodiment may include a carrier 420 inserted into and installed in a base 410, a driving unit 430 configured to move the carrier 420 along an optical axis direction, and at least one or more balls 440 located between the base 410 and the carrier 420. The driving unit 430 may include a magnet 433 installed in one surface of the carrier 420 and a coil 435 installed in the base 410 to face the magnet 433.

A receiving groove 412 configured to receive the carrier 420 and guide grooves G2 into which balls 440 are inserted may be formed in the base 410. The receiving groove 412 may have a shape corresponding to an outer surface of the carrier 420 and the guide grooves G2 may be coupled to the receiving groove 412 and may have a concave shape from an inner surface of the base 410 so that the balls 440 are inserted into the guide grooves G2.

An opening 418 which exposes the magnet 433 to the outside may be formed in one surface of the base 410 and the coil 435 may be installed to face the magnet 433 through the opening 418. The guide grooves G2 may include a main guide groove 413 located in one side of the magnet 433 and an auxiliary guide groove 414 located in the other side of the magnet 433. The balls 440 may be stacked and located in the main guide groove 413 and the auxiliary guide groove 414. As described in FIGS. 6 and 7, the position of the auxiliary guide groove 414 may be variously modified.

In the autofocus adjustment apparatus 400 according to another exemplary embodiment, a lens barrel 450 and the carrier 420 are integrally formed. In response to the lens barrel 450 and the carrier 420 being combined, the optical axis of the lens has to be arranged perpendicular to an imaging forming plane of an image sensor to improve accuracy and resolution of the autofocus. This is because the resolution of the lens may be adversely affected in response to the optical axis of the lens being not arranged perpendicular to the imaging forming plane of the image sensor.

For example, in response to the optical axis of the lens being not arranged perpendicular to the imaging forming plane of the image sensor due to the tolerance of the assembly process or the manufacturing process of the autofocus adjustment apparatus 400, the accuracy and resolution of the lens may be adversely affected. Accordingly, the determining whether or not the optical axis of the lens is arranged perpendicular to the imaging forming plane of the image sensor may correspond to a very important factor of the autofocus adjustment apparatus.

The autofocus adjustment apparatus 400 according to another exemplary embodiment may meet the elevation criteria of the autofocus adjustment apparatus 400 by integrally manufacturing the lens barrel 450 and the carrier 420. In response to the lens barrel 450 being fastened to the carrier 420 to be in focus, foreign materials due to friction caused by coupling between the lens barrel 450 and the carrier 420 may be prevented from being generated in advance.

FIG. 8, reference numeral 415 which has not been described in the detailed description refers to a light-through hole, reference numeral 425 refers to a guide protrusion, reference numeral 428 refers to a coupling member, reference numeral 429 refers to a installation groove, reference numeral 460 refers to a substrate, and reference numeral 465 refers to a yoke.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An autofocus adjustment apparatus comprising:
a base formed with a light-through hole;
a carrier inserted into the base and configured to receive a lens barrel configured of one or more lenses;
a magnet installed in one surface of the carrier;
a coil installed in the base to face the magnet; and
at least one or more balls located between the carrier and the base and configured to support the carrier to move along an optical axis direction of the lenses,
wherein the base includes guide grooves into which the balls are inserted,
the guide grooves include a main guide groove which is located in one side of the magnet and at least one end of a guide protrusion protruding from the carrier is inserted thereinto and an auxiliary guide groove located in the other side of the magnet,
the balls inserted into the main guide groove are disposed in both sides of the guide protrusion to support the carrier to an X-Y direction, and
the balls inserted into the auxiliary guide groove are in two-point contact to support the carrier to a Y-direction.

2. The autofocus adjustment apparatus as claimed in claim 1, wherein a receiving groove configured to receive the carrier is formed in the base, and
the guide grooves formed in the base are coupled to the receiving groove along the optical axis direction.

3. The autofocus adjustment apparatus as claimed in claim 1, wherein the balls are stacked in and inserted into the main guide groove and the auxiliary guide groove in different numbers.

4. The autofocus adjustment apparatus as claimed in claim 2, wherein the balls inserted into the main guide groove are in three-point contact between the carrier and the base, and
the balls inserted into the auxiliary guide groove are in two-point contact between the carrier and the base.

5. The autofocus adjustment apparatus as claimed in claim 1, wherein the main guide groove is partitioned into a first main guide groove and a second main guide groove through the guide protrusion, and
the balls are stacked in the first main guide groove and the second main guide groove.

6. The autofocus adjustment apparatus as claimed in claim 5, wherein the guide protrusion includes inclined surfaces which are in contact with the balls located in the first and second main guide grooves.

7. The autofocus adjustment apparatus as claimed in claim 6, wherein the balls located in the first and second main guide grooves are in three-point contact between the inclined surfaces and the first and second main guide grooves.

8. The autofocus adjustment apparatus as claimed in claim 1, wherein a plurality of polarities are alternately formed in the magnet.
